(19) United States
(12) Patent Application Publication
(10) Pub. No.: US 2026/0140913 A1
(43) Pub. Date: May 21, 2026

(54) WIRELESS UNIVERSAL SERIAL BUS HUB AND OPERATION METHOD THEREOF

(71) Applicant: Chung-Ping Hsu, Taipei City (TW)

(72) Inventor: Chung-Ping Hsu, Taipei City (TW)

(73) Assignee: ITE Tech. Inc., Hsinchu (TW)

(21) Appl. No.: 19/178,799

(22) Filed: Apr. 14, 2025

(30) Foreign Application Priority Data
Nov. 18, 2024 (TW) 113144223

(51) Int. Cl. G06F 13/42; H04L 27/26

(52) U.S. Cl. CPC G06F 13/4282; H04L 27/2627; G06F 2213/0042

(57) ABSTRACT

A wireless universal serial bus hub and an operation method thereof are provided. The wireless universal serial bus hub includes a local side device and a remote side device. The remote side device is communicatively connected to the local side device. The local side device receives at least one data, at least one check code, and at least one identifier from at least one first device respectively. The local side device generates a data packet based on the at least one data, the at least one check code, and the at least one identifier and wirelessly transmits the data packet to the remote side device. The remote side device generates serial differential data based on the data packet and outputs the serial differential data to a second device.

### CROSS-REFERENCE TO RELATED APPLICATION

This application claims the priority benefit of Taiwan application serial no. 113144223, filed on Nov. 18, 2024. The entirety of the above-mentioned patent application is hereby incorporated by reference herein and made a part of this specification.

### BACKGROUND OF THE INVENTION

### Field of the Invention

The invention relates to an electronic device, and in particular to a wireless universal serial bus hub and an operation method thereof.

### Description of Related Art

A general Universal Serial Bus (USB) hub is an electronic device connected between a host device and a plurality of USB devices to expand the USB interface of the host device. In other words, a USB hub may be used to connect a plurality of USB devices to one USB interface of a host device. Please refer to FIG. 1. FIG. 1 shows a schematic diagram of a conventional universal serial bus (USB) hub, source device, and host device. A USB hub 10 in FIG. 1 includes USB interfaces 11-1 to 11-N, a hub controller 12, and a port physical layer circuit 13. Source devices 21-1 to 21-N of FIG. 1 may be, for example, USB devices and are coupled to the USB interfaces 11-1 to 11-N. A host device 22 is coupled to a USB interface 14.

As shown in FIG. 1, the source devices 21-1 to 21-N may be connected to the host device 22 via the USB hub 10 respectively. During the process of transmitting data from the source devices 21-1 to 21-N to the host device 22, data may be transmitted from the USB interface 14 to the host device 22 after being processed by the hub controller 12 and the port physical layer circuit 13 via the USB interfaces 11-1 to 11-N.

In general, the source devices 21-1 to 21-N and the host device 22 may be connected to the USB hub 10 respectively via a USB transmission cable (not shown), for example. As a result, the source devices 21-1 to 21-N and the host device 22 need to be disposed within a limited range, causing inconvenience to the user.

### SUMMARY OF THE INVENTION

Accordingly, the invention provides a wireless universal serial bus hub and an operation method thereof that may improve the convenience and flexibility of use.

A wireless universal serial bus hub of the invention includes a local side device and a remote side device. The remote side device is communicatively connected to the local side device. The local side device receives at least one data, at least one check code, and at least one identifier from at least one first device respectively. The local side device generates a data packet based on the at least one data, the at least one check code, and the at least one identifier and wirelessly transmits the data packet to the remote side device. The remote side device generates serial differential data based on the data packet. The remote side device outputs the serial differential data to a second device.

An operation method of a wireless universal serial bus hub of the invention includes: receiving at least one data, at least one check code, and at least one identifier from at least one first device respectively via a local side device; generating a data packet based on the at least one data, the at least one check code, and the at least one identifier and wirelessly transmitting the data packet to a remote side device via the local side device; generating serial differential data based on the data packet via the remote side device; and outputting the serial differential data to a second device via the remote side device.

Based on the above, the wireless universal serial bus hub and the operation method thereof provided by the invention may wirelessly transmit the data from the first device to the second device via the local side device and the remote side device to solve the configuration limitation on the distance of the first device and the second device, so as to effectively improve the convenience and flexibility of use.

In order to make the aforementioned features and advantages of the disclosure more comprehensible, embodiments accompanied with figures are described in detail below.

### BRIEF DESCRIPTION OF THE DRAWINGS

FIG. 1 shows a schematic diagram of a conventional universal serial bus (USB) hub, source device, and host device.

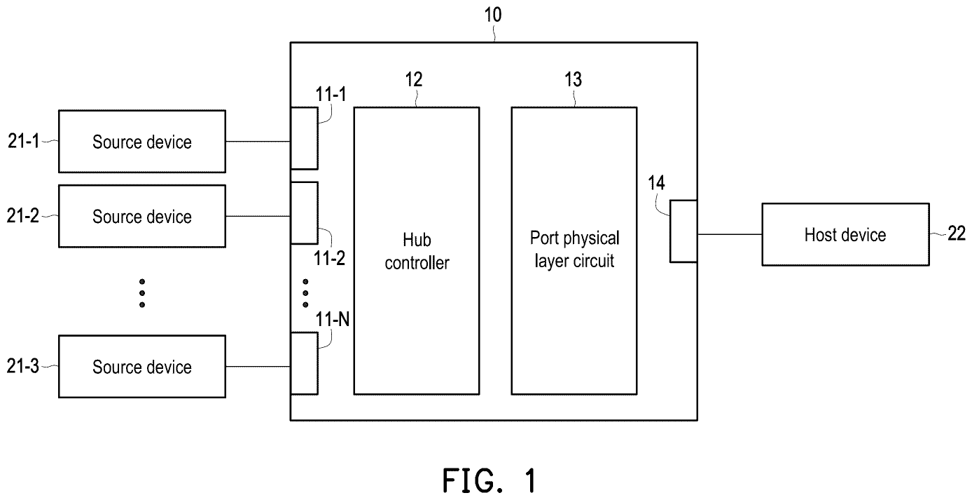

FIG. 2 shows a schematic diagram of a wireless USB hub, a first device, and a second device of an embodiment of the invention.

FIG. 3 shows a schematic diagram of a wireless USB hub of an embodiment of the invention.

FIG. 4 shows a flowchart of an operation method applicable to a wireless USB hub of an embodiment of the invention.

FIG. 5 shows a flowchart of an operation method of a wireless USB hub of an embodiment of the invention.

### DESCRIPTION OF THE EMBODIMENTS

A portion of the embodiments of the invention is described in detail hereinafter with reference to figures. In the following, the same reference numerals in different figures should be considered to represent the same or similar elements. These embodiments are only a portion of the invention and do not disclose all possible implementations of the invention. Rather, the embodiments are merely examples within the claims of the invention.

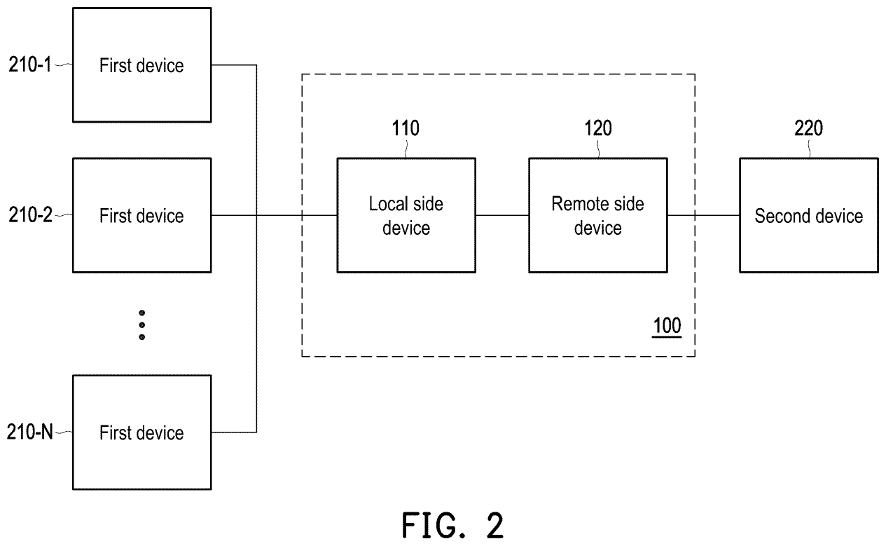

FIG. 2 shows a schematic diagram of a wireless USB hub, a first device, and a second device of an embodiment of the invention. Please refer to FIG. 2.

In the present embodiment, a wireless USB hub 100 includes a local side device 110 and a remote side device 120. The local side device 110 is communicatively connected to the remote side device 120. First devices 210-1 to 210-N are coupled to the local side device 110. For example, the first devices 210-1 to 210-N may be coupled to the local device 110 via a USB transmission cable (not shown) respectively. A second device 220 is coupled to the remote side device 120. For example, the second device 220 may be coupled to the remote side device 120 via a USB transmission cable (not shown).

The first devices 210-1 to 210-N may be, for example, common input and output devices such as keyboards and mice, or electronic equipment such as memory storage devices and audio and video devices.

The second device 220 may be, for example, a host device, and may include, but is not limited to, a processor, a random-access memory (RAM), a read-only memory (ROM), a data transfer interface, and a USB connector. For example, the second device 220 may be an electronic equipment such as a desktop computer, a tablet computer, a notebook computer, a television, a monitor, or the like.

In the present embodiment, the distance between the local side device 110 and the remote side device 120 is greater than a predetermined distance. Specifically, the local side device 110 may be, for example, a portable device, and may be placed at any location by the user as needed, and used to be coupled to the first devices 210-1 to 210-N. In addition, the remote side device 120 may be, for example, disposed at a location away from the local side device 110 at a predetermined distance, and used to be coupled to the second device 220. The predetermined distance may be, for example, greater than the distance of a conventional USB transmission line, or may be designed by the user according to actual needs, and the invention is not limited in this regard.

In the present embodiment, the first devices 210-1 to 210-N are connected to the local side device 110, and the second device 220 is connected to the remote side device 120. The local side device 110 may receive data, a check code, and an identifier corresponding to the first devices 210-1 to 210-N respectively from the first devices 210-1 to 210-N. Next, the local side device 110 may generate a data packet based on the data, the check code, and the identifier, and wirelessly transmit the data packet to the remote side device 120 at a predetermined distance. After the remote side device 120 receives the data packet, the remote side device 120 may generate serial differential data based on the data packet and output the serial differential data to the second device 220.

In another embodiment, the distance between the local side device 110 and the remote side device 120 may also be equal to or less than the predetermined distance, and the invention is not limited in this regard.

Accordingly, the wireless USB hub 100 of the invention may wirelessly transmit the data from the first devices 210-1 to 210-N to the second device 220 located at a predetermined distance via the local side device 110 and the remote side device 120 to solve the limitation on the configuration distance of the first devices 210-1 to 210-N and the second device 220, so as to effectively improve the convenience and flexibility of use.

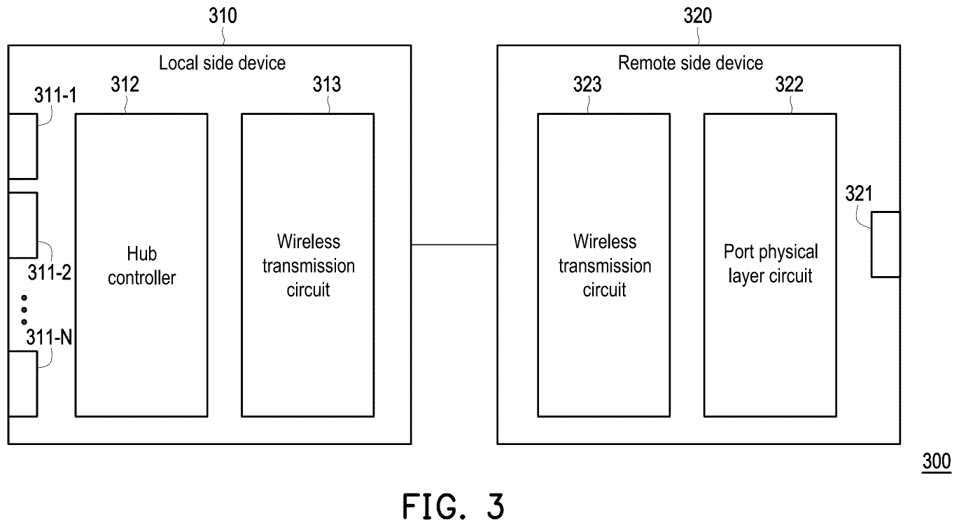

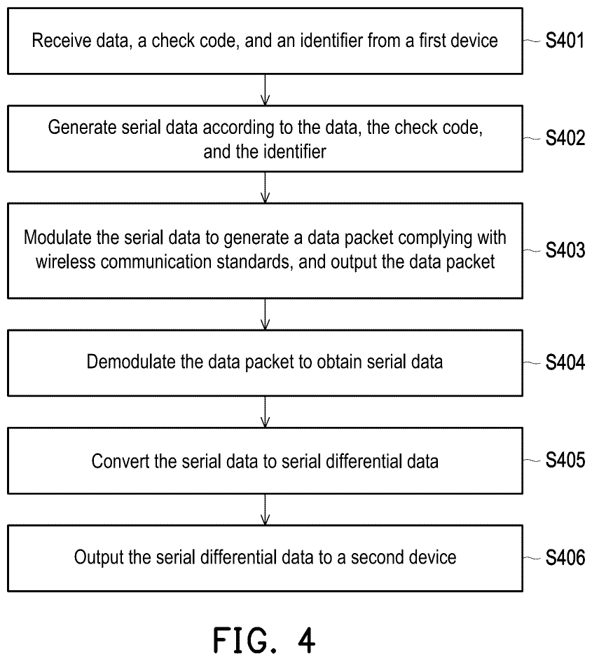

FIG. 3 shows a schematic diagram of a wireless USB hub of an embodiment of the invention; FIG. 4 shows a flowchart of an operation method applicable to a wireless USB hub of an embodiment of the invention. Please refer to FIG. 2 to FIG. 4 at the same time.

In the present embodiment, a wireless USB hub 300 includes a local side device 310 and a remote side device 320. The local side device 310 may include, but is not limited to, USB interfaces 311-1 to 311-N, a hub controller 312, and a wireless transmission circuit 313. The remote side device 320 may include, but is not limited to, a USB interface 321, a port physical layer (PHY) circuit 322, and a wireless transmission circuit 323.

The USB interfaces 311-1 to 311-N and 321 may be interfaces complying with a USB specification. For example, the USB interfaces 311-1 to 311-N and 321 may respectively be, for example, an interface complying with USB 2.0 specification (USB 2.0 Transceiver Macrocell Interface, UTMI), an interface complying with USB 3.0 specification (PHY Interface for the PCI Express and USB 3.0, PIPE), or an interface complying with USB-C (USB Type-C) specification.

The hub controller 312 may, for example, be used to control connections with the first devices 210-1 to 210-N and/or control data from the first devices 210-1 to 210-N.

The PPL circuit 322 may, for example, be used to encode data from the local side device 310 (the hub controller 312) according to the USB specification and convert the data to serial differential data.

According to different requirements, in some embodiments, the hub controller 312 and/or the PPL circuit 322 may be implemented as hardware circuits. In other embodiments, the hub controller 312 and/or the PPL circuit 322 may be implemented as firmware. In some other embodiments, the hub controller 312 and/or the PPL circuit 322 may be implemented as a combination of hardware, firmware, and/or software.

If implemented as a hardware, the hub controller 312 may be implemented as a logic circuit on an integrated circuit. For example, the related functions of the hub controller 312 may be one or more controllers, micro control units (MCUs), microprocessors, application-specific integrated circuits (ASICs), digital signal processors (DSPs), field-programmable gate arrays (FPGAs) or other similar elements, or a combination of the above elements. In addition, the PPL circuit 322 may be, for example, a physical layer chip or device known to those skilled in the art.

The wireless transmission circuits 313 and 323 may be, for example, orthogonal frequency-division multiplexing (OFDM) transceivers transmitting and outputting signals (or data) in a wireless manner. That is, the local side device 310 and the remote side device 320 may perform two-way transmission via the wireless transmission circuits 313 and 323 (i.e., OFDM transceivers). The wireless transmission circuits 313 and 323 may, for example, include a serial-to-parallel converter, a signal mapping circuit, a digital signal processor, or other similar elements, or a combination of the above elements. The wireless transmission circuits 313 and 323 may be used to perform, for example, low-noise amplification, impedance matching, mixing, up or down frequency conversion, filtering, amplification, modulation, demodulation, adding guard interval data, and similar operations.

When a user is to use the near-end device (for example, the first device 210-1 and the first device 210-2) as an expansion electronic equipment for a host device (for example, the second device 220) located at a predetermined distance, the user may connect the first device 210-1 and the first device 210-2 to a USB interface 311-1 and a USB interface 311-2 of the local side device 310 respectively, and connect the second device 220 to the remote side device 320. For example, the first devices 210-1 and 210-2 may be connected to the USB interfaces 311-1 and 311-2 respectively via a USB transmission cable (not shown). For example, the second device 220 may be connected to the USB interface 321 via a USB transmission cable (not shown). Accordingly, data may be transmitted between the first devices 210-1 and 210-2 and the second device 220. Taking the situation of outputting data from the first devices 210-1 and 210-2 to the second device 220 as an example, please refer to FIG. 4 for implementation details.

In step S401, the local side device 310 may receive data, a check code, and an identifier from the first devices 210-1 and 210-2. Specifically, the local side device 310 may receive the data, the check code, and the identifier from the first devices 210-1 and 210-2 respectively via the USB interfaces 311-1 and 311-2. In the present embodiment, the check code may be, for example, a cyclic redundancy check (CRC) code. In the present embodiment, the identifier may be, for example, a product identifier (PID), and the first devices 210-1 and 210-2 respectively have exclusive product identifiers.

In step S402, the local side device 310 may generate serial data according to the data, the check code, and the identifier. Specifically, the hub controller 312 in the local side device 310 may generate the serial data according to the data, the check code, and the identifier of the first device 210-1 and the data, the check code, and the identifier of the first device 210-2. For example, the hub controller 312 may collect the data, the check code, and the identifier of the first device 210-1 and the data, the check code, and the identifier of the first device 210-2 into the same data to generate the serial data.

In step S403, the local side device 310 may modulate the serial data to generate a data packet complying with the wireless communication standard, and output the data packet. Specifically, the wireless transmission circuit 313 in the local side device 310 may modulate the serial data generated in step S402 to generate a data packet complying with the wireless communication standard, and wirelessly transmit the data packet to the remote side device 320. In the present embodiment, the wireless communication standard may be, for example, the orthogonal frequency division multiplexing (OFDM) standard. The OFDM standard may include 3rd Generation Partnership Project (3GPP) Long Term Evolution (LTE), Institute of Electrical and Electronics Engineers (IEEE) 802.16 standard, and IEEE 802.11 standard.

In step S404, the remote side device 320 may demodulate the data packet to obtain the serial data. Specifically, the wireless transmission circuit 323 in the remote side device 320 may receive the data packet from the local side device 310 and demodulate the data packet to obtain the serial data.

In step S405, the remote side device 320 may convert the serial data to serial differential data. Specifically, the PPL circuit 322 in the remote side device 320 encodes the serial data according to the USB specification to be converted to the serial differential data.

In step S406, the remote side device 320 may output the serial differential data to the second device 220. Specifically, the PPL circuit 322 in the remote side device 320 may output the serial differential data to the second device 220 via the USB interface 321.

It should be noted that FIG. 4 shows the process of transmitting data (or signals) from the first devices 210-1 and 210-2 to the second device 220. Regarding the process of transmitting data (or signals) from the second device 220 to the first devices 210-1 and 210-2, the operating principle thereof is the same as that in FIG. 4, so inference may be made in reverse according to the process of FIG. 4. In addition, the wireless USB hub 300 may also complete the data transmission of the above two different directions at the same time via the wireless transmission circuits 313 and 323.

It is worth mentioning that the wireless transmission circuits 313 and 323 of the local side device 310 and the remote side device 320 have an orthogonal frequency division multiplexing (OFDM) encoder and an orthogonal frequency division multiplexing (OFDM) decoder. Before data is transmitted, the local side device 310 (or the remote side device 320) needs to encode or modulate the data to be transmitted to facilitate wireless transmission of the data. Next, the remote side device 320 (or the local side device 310) needs to decode or demodulate the received data to obtain correct data.

According to the above, in the wireless USB hub 300 of the invention, by disposing the hub controller 312 and the PPL circuit 322 at the local side device 310 and the remote side device 320 respectively, and disposing the wireless transmission circuits 313 and 323 in the local side device 310 and the remote side device 320 respectively, the data of the first devices 210-1 and 210-2 (or the second device 220) may be wirelessly transmitted to the second device 220 (or the first devices 210-1 and 210-2) located at a predetermined distance to solve the limitation on the configuration distance of the first devices 210-1 and 210-2 and the second device 220, so as to effectively improve the convenience and flexibility of use.

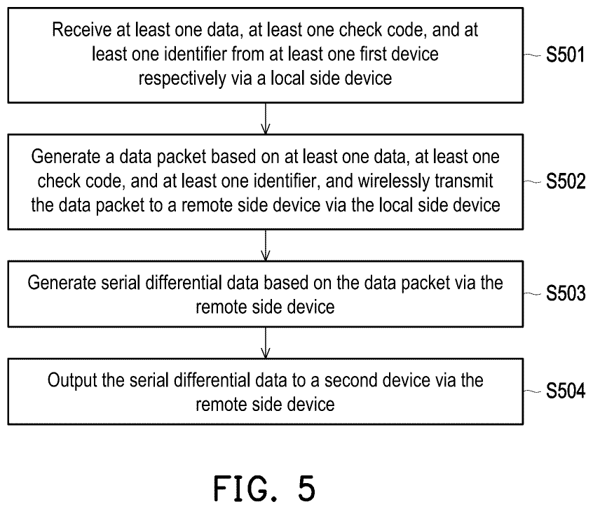

FIG. 5 shows a flowchart of an operation method of a wireless USB hub of an embodiment of the invention. The operation method of the present embodiment may be performed by the wireless USB hub 100 of FIG. 2. Please refer to FIG. 2 and FIG. 5 at the same time.

In step S501, at least one data, at least one check code, and at least one identifier are respectively received from at least one first device 210-1 to 220-N via the local side device 110. In step S502, via the local side device 110, a data packet is generated based on the at least one data, the at least one check code, and the at least one identifier, and the data packet is wirelessly transmitted to the remote side device 120. In step S503, serial differential data is generated based on the data packet via the remote side device 120. In step S504, the serial differential data is output to the second device 220 via the remote side device 120.

The implementation details of steps S501 to S504 are described in detail in the above embodiments and are therefore not repeated herein.

Based on the above, in the wireless universal serial bus hub and the operation method thereof provided by the embodiment of the invention, by disposing the hub controller and the PPL circuit at the local side device and the remote side device respectively, and disposing the wireless transmission circuit in the local side device and the remote side device, two-way transmission of data may be performed between the near-end device and the host device in a wireless manner to solve the limitation of the configuration distance of the near-end device and the host device, so as to effectively improve the convenience and flexibility of use.

What is claimed is:

1. A wireless universal serial bus (USB) hub, comprising:
a local side device; and
a remote side device communicatively connected to the local side device,
wherein the local side device receives at least one data, at least one check code, and at least one identifier from at least one first device respectively, generates a data packet based on the at least one data, the at least one check code, and the at least one identifier, and wirelessly transmits the data packet to the remote side device, and
the remote side device generates serial differential data based on the data packet and outputs the serial differential data to a second device.

2. The wireless USB hub of claim 1, wherein a distance between the local side device and the remote side device is greater than a predetermined distance.

3. The wireless USB hub of claim 1, wherein the local side device further comprises:
a plurality of first USB interfaces, wherein at least one first USB interface in the first USB interfaces is respectively used to be coupled to the at least one first device, and respectively receive the at least one data, the at least one check code, and the at least one identifier from the at least one first device.

4. The wireless USB hub of claim 1, wherein the local side device further comprises:
a hub controller used to generate serial data according to the at least one data, the at least one check code, and the at least one identifier; and
a first wireless transmission circuit used to modulate the serial data to generate the data packet complying with a wireless communication standard, and wirelessly transmit the data packet to the remote side device.

5. The wireless USB hub of claim 4, wherein the wireless communication standard is an orthogonal frequency-division multiplexing (OFDM) standard.

6. The wireless USB hub of claim 1, wherein the remote side device further comprises:
a second wireless transmission circuit used to receive the data packet from the local side device and demodulate the data packet to obtain serial data; and
a port physical layer (PHY) circuit used to convert the serial data to the serial differential data.

7. The wireless USB hub of claim 1, wherein the remote side device comprises:
a second USB interface used to be coupled to the second device and output the serial differential data to the second device.

8. An operation method of a wireless USB hub, comprising:
receiving at least one data, at least one check code, and at least one identifier from at least one first device respectively via a local side device;
generating a data packet based on the at least one data, the at least one check code, and the at least one identifier and wirelessly transmitting the data packet to a remote side device via the local side device;
generating serial differential data based on the data packet via the remote side device; and
outputting the serial differential data to a second device via the remote side device.

9. The operation method of claim 8, wherein a distance between the local side device and the remote side device is greater than a predetermined distance.

10. The operation method of claim 8, wherein the step of receiving the at least one data, the at least one check code, and the at least one identifier respectively from the at least one first device via the local side device further comprises:
receiving the at least one data, the at least one check code, and the at least one identifier respectively from the at least one first device via at least one first USB interface of the local side device.

11. The operation method of claim 8, wherein the step of generating the data packet based on the at least one data, the at least one check code, and the at least one identifier and wirelessly transmitting the data packet to the remote side device via the local side device further comprises:
generating serial data according to the at least one data, the at least one check code, and the at least one identifier via a hub controller; and
modulating the serial data to generate the data packet complying with a wireless communication standard, and wirelessly transmitting the data packet to the remote side device via a first wireless transmission circuit.

12. The operation method of claim 11, wherein the wireless communication standard is an orthogonal frequency division multiplexing standard.

13. The operation method of claim 8, wherein the step of generating the serial differential data based on the data packet via the remote side device further comprises:
receiving the data packet from the local side device and demodulating the data packet via a second wireless transmission circuit to obtain the serial data; and
converting the serial data to the serial differential data via a PPL circuit.

14. The operation method of claim 8, wherein the step of outputting the serial differential data to the second device via the remote side device further comprises:
outputting the serial differential data to the second device via a second USB interface.
